(19) United States
(12) Patent Application Publication
(10) Pub. No.: US 2026/0165552 A1
(43) Pub. Date: Jun. 18, 2026

(54) CONTROL METHOD AND APPARATUS OF AUTOMATIC CLEANING DEVICE, MEDIUM, AND AUTOMATIC CLEANING DEVICE

(71) Applicant: Beijing Roborock Innovation Technology Co., Ltd., Beijing (CN)

(72) Inventors: Jianqiang SHAN, Beijing (CN); Kaijing WANG, Beijing (CN)

(73) Assignee: Beijing Roborock Innovation Technology Co., Ltd., Beijing (CN)

(21) Appl. No.: 19/536,026

(22) Filed: Feb. 10, 2026

Related U.S. Application Data
(63) Continuation of application No. PCT/CN2024/125309, filed on Oct. 16, 2024.

(30) Foreign Application Priority Data
Aug. 25, 2023 (CN) 202311091134.4

(51) Int. Cl. A47L 13/16; A47L 11/40; B08B 9/093

(52) U.S. Cl. CPC A47L 13/16; A47L 11/4011; B08B 9/093; A47L 2201/04

(57) ABSTRACT

The invention discloses a control method of an automatic cleaning device, a medium, and an automatic cleaning device. The method includes: during operation of the automatic cleaning device, continuously obtaining an action position for triggering a telescopic mopping module of the automatic cleaning equipment to execute a telescopic action; on the basis of the obtained plurality of action positions, determining whether the automatic cleaning device meets a telescopic action restricting condition; and, when the automatic cleaning device meets the telescopic action limiting condition, restricting the use of the telescopic mopping module in order to suspend the ability of the telescopic mopping module to execute a telescopic action.

### CROSS-REFERENCE TO RELATED APPLICATION

The present disclosure is a continued application of copending PCT application No. PCT/CN2024/125309, filed on Oct. 16, 2024, which claims priority to Chinese Patent Application No. 202311091134.4 filed on Aug. 25, 2023, which is incorporated herein by reference in its entirety as a part of the present disclosure.

### TECHNICAL FIELD

The present disclosure relates to the technical field of smart home appliances, and in particular to a method and apparatus for controlling an automatic cleaning device, a storage medium, and an automatic cleaning device.

### BACKGROUND

At present, to solve the problem of edge and corner cleaning, many manufacturers have added a retractable mopping assembly to the sweeping robot. The assembly extends a mop when moving along obstacles, thereby improving edge and corner coverage.

However, in actual usage scenarios, for example, in areas with many surrounding obstacles or narrow spaces, frequent actions of extending and retracting the mop will reduce the sweeping efficiency of the robot. In addition, the frequent actions of extending and retracting the cloth will also affect the service life of the retractable mopping assembly, thereby affecting the service life of the sweeping robot.

How to control the retractable mopping assembly more reasonably to improve the sweeping efficiency and extend the service life of the sweeping robot is a problem worthy of exploration in the art.

### SUMMARY

In view of this, the present disclosure provides a method and apparatus for controlling an automatic cleaning device, a storage medium, and an automatic cleaning device. By means of determining an obstacle-dense area and restricting the extension-retraction action of a retractable mopping assembly in the area, the problems of low sweeping efficiency and reduced service life of the mopping assembly caused by frequent extension-retraction of the mop of existing automatic cleaning devices in areas with many obstacles or narrow spaces are solved.

According to an aspect of the present disclosure, a method for controlling an automatic cleaning device is provided. The method includes:
continuously acquiring, during operation of an automatic cleaning device, action positions where a retractable mopping assembly of the automatic cleaning device is triggered to perform an extension-retraction action;
determining, based on the plurality of action positions acquired, whether the automatic cleaning device satisfies an extension-retraction action restriction condition; and
imposing a usage restriction on the retractable mopping assembly when the automatic cleaning device satisfies the extension-retraction action restriction condition, so as to suspend a capability of the retractable mopping assembly to perform the extension-retraction action.

According to another aspect of the present disclosure, an apparatus for controlling an automatic cleaning device is provided. The apparatus includes:
an acquisition module, configured to continuously acquire, during operation of an automatic cleaning device, action positions where a retractable mopping assembly of the automatic cleaning device is triggered to perform an extension-retraction action;
a determination module, configured to determine, based on the plurality of action positions acquired, whether the automatic cleaning device satisfies an extension-retraction action restriction condition; and
a control module, configured to impose a usage restriction on the retractable mopping assembly when the automatic cleaning device satisfies the extension-retraction action restriction condition, so as to suspend a capability of the retractable mopping assembly to perform the extension-retraction action.

According to yet another aspect of the present disclosure, a non-transitory storage medium storing a computer program is provided. The computer program, when run by a processor, causes the processor to perform the above method for controlling the automatic cleaning device.

According to still another aspect of the present disclosure, an automatic cleaning device is provided. The automatic cleaning device includes a storage medium, a processor, and a computer program stored in the storage medium and executable on the processor. The processor, when running the computer program, is caused to perform the above method for controlling the automatic cleaning device.

The above description is only an overview of the technical solutions of the present disclosure. To more clearly understand the technical means of the present disclosure to enable implementation in accordance with the content of the specification and to make the above and other objectives, features, and advantages of the present disclosure more obvious and easy to understand, the detailed description of the present disclosure is provided below.

### BRIEF DESCRIPTION OF THE DRAWINGS

The drawings described herein are used to provide a further understanding of the present disclosure, and constitute a part of the present disclosure. The exemplary embodiments of the present disclosure and descriptions thereof are used to explain the present disclosure, and do not constitute improper limitations to the present disclosure. In the drawings:

FIG. 1 shows a schematic flowchart of a method for controlling an automatic cleaning device according to one embodiment of the present disclosure;

FIG. 2 shows a schematic flowchart of a method for controlling an automatic cleaning device according to one embodiment of the present disclosure;

FIG. 3 shows a schematic diagram of a restricted area identification range of a method for controlling an automatic cleaning device according to one embodiment of the present disclosure;

FIG. 4 shows a schematic diagram of leaving a restricted area identification range of a method for controlling an automatic cleaning device according to one embodiment of the present disclosure;

FIG. 5 shows a schematic flowchart of a method for controlling an automatic cleaning device according to one embodiment of the present disclosure; and

FIG. 6 is a structural block diagram of an apparatus for controlling an automatic cleaning device according to one embodiment of the present disclosure.

### DETAILED DESCRIPTION

The present disclosure will be described in detail below with reference to the drawings and in conjunction with the embodiments. It should be noted that the embodiments of the present disclosure and the features in the embodiments may be combined with each other without conflict.

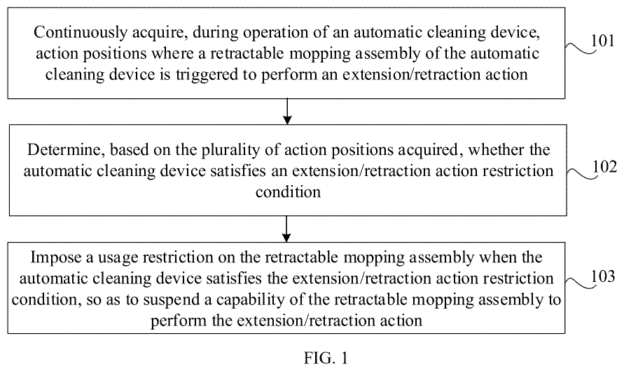

In one embodiment, a method for controlling an automatic cleaning device is provided. As shown in FIG. 1, the method includes:

In step 101, during operation of an automatic cleaning device, action positions where a retractable mopping assembly of the automatic cleaning device is triggered to perform an extension-retraction action (i.e., telescopic action) are continuously acquired.

The method for controlling the automatic cleaning device according to the embodiment of the present application above is applicable to an automatic cleaning device, such as a sweeping robot. The automatic cleaning device is provided with a retractable mopping assembly. During cleaning of the automatic cleaning device, the mopping assembly may be extended to clean a narrow space such as a corner, or a position where movement is inconvenient due to a large number of obstacles, while in an open and wide space, the mopping assembly may be retracted, allowing a conventional cleaning mode to be adopted. However, the frequent extension-retraction action will affect the service life of the retractable mopping assembly and also reduce the sweeping efficiency. Based on this, the extension-retraction action of the automatic cleaning device may be restricted according to the environment of the space where the automatic cleaning device is located, and the extension-retraction action is performed only in a scenario where the extension-retraction action is necessary, thereby reducing the number of times of performing the extension-retraction action in other scenarios.

In this step, the environment where the automatic cleaning device is currently located may be determined based on the extension-retraction action of the retractable mopping assembly and the position of the retractable mopping assembly when the action occurs. It can be understood that, after the automatic cleaning device extends the retractable mopping assembly, the automatic cleaning device may be kept in an extended state for a period of time until the cleaning is completed, and then retracted. During this period of time, the automatic cleaning device may move, that is, the position of the automatic cleaning device may change. Based on this, the position where the retractable mopping assembly is triggered to perform the extension-retraction action may be taken as an action position. In this case, whether the retractable mopping assembly of the automatic cleaning device is triggered to perform the extension-retraction action is continuously determined, a corresponding action position is acquired when the extension-retraction action is detected to be triggered, and then whether an extension-retraction action restriction condition is satisfied is determined according to the action position.

In step 102, whether the automatic cleaning device satisfies an extension-retraction action restriction condition is determined based on the plurality of action positions acquired.

In this step, if a plurality of action positions are acquired, it indicates that the retractable mopping assembly is triggered to perform an extension-retraction action for a plurality of times, that is, the retractable mopping assembly extends and retracts for a plurality of times. Since the service life of the device will be reduced due to too many times of extension-retraction, it is determined whether the automatic cleaning device satisfies an extension-retraction action restriction condition, for example, when the number of times of extension-retraction action or the frequency of extension-retraction action meets a certain requirement.

In step 103, when the automatic cleaning device satisfies the extension-retraction action restriction condition, a usage restriction is imposed on the retractable mopping assembly, so as to suspend a capability of the retractable mopping assembly to perform the extension-retraction action.

In this step, if the automatic cleaning device satisfies the extension-retraction action restriction condition, the extension-retraction action of the automatic cleaning device is restricted. For example, the frequency of performing the extension-retraction action is restricted, or the retractable mopping assembly is directly prohibited from continuing to perform the extension-retraction action within a certain period of time or in a certain area. In this step, by means of such a configuration, the number of times of extension-retraction of the automatic cleaning device during operation is reduced, thereby prolonging the service life of the automatic cleaning device.

In this embodiment, the action position of the retractable mopping assembly of the automatic cleaning device when the retractable mopping assembly triggers the extension-retraction action is acquired, and the environment of the space where the automatic cleaning device is currently located, such as a corner or a narrow space, is determined according to the action position acquired, so as to determine whether the extension-retraction action of the automatic cleaning device can be restricted. When it is determined that the extension-retraction action restriction condition is satisfied, the extension-retraction action of the retractable mopping assembly is restricted, so as to avoid the service life being affected by too many times of extension-retraction of the retractable mopping assembly, and also avoid the problems of low sweeping efficiency and the like caused by frequent extension-retraction of the mopping assembly.

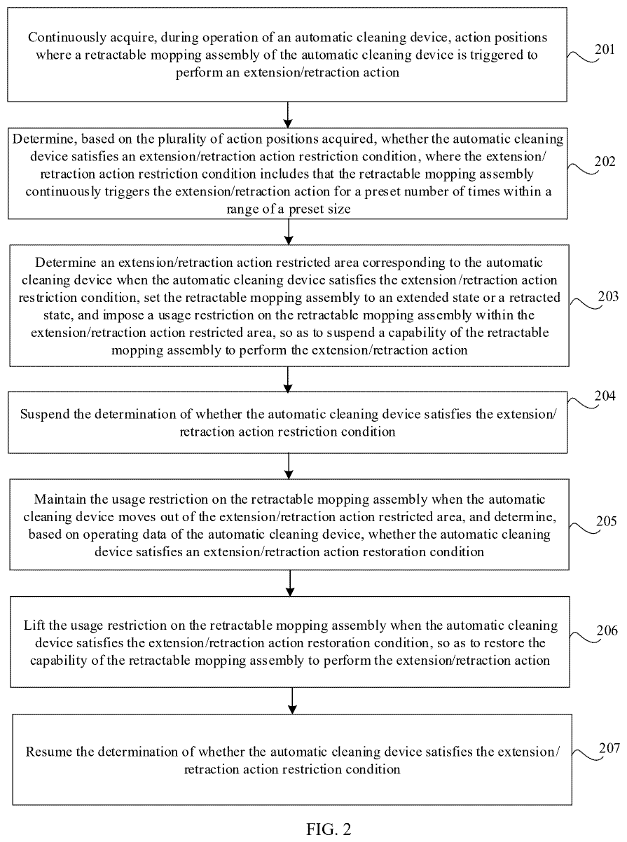

Further, as a refinement and extension of the specific implementation of the above embodiment, in order to fully illustrate the specific implementation process of the embodiment, another method for controlling an automatic cleaning device is provided. As shown in FIG. 2, the method includes:

In step 201, during operation of an automatic cleaning device, action positions where a retractable mopping assembly of the automatic cleaning device is triggered to perform an extension-retraction action are continuously acquired.

In step 202, whether the automatic cleaning device satisfies an extension-retraction action restriction condition is determined based on the plurality of action positions acquired, where the extension-retraction action restriction condition includes that the retractable mopping assembly continuously triggers the extension-retraction action for a preset number of times within a range of a preset size.

In step 202, whether an extension-retraction action restriction condition is satisfied is determined according to the number of times that the retractable mopping assembly continuously triggers an extension-retraction action within a range of a preset size. Specifically, if the number of times of continuously triggering the extension-retraction action reaches the preset number of times, it is considered that the number of times that the retractable mopping assembly performs the extension-retraction action is too large, and the extension-retraction action needs to be restricted. Therefore, it is determined that the automatic cleaning device satisfies the extension-retraction action restriction condition.

In addition, in step 202, the determining, based on the plurality of action positions acquired, whether the automatic cleaning device satisfies the extension-retraction action restriction condition includes the following steps.

In step 2021, taking any one of the action positions acquired as an identification start position, a restricted area identification range of the preset size corresponding to the identification start position is determined; a number of times that the action positions continuously acquired from the identification start position fall within the restricted area identification range is counted; and if the number of times reaches the preset number of times, it is determined that the automatic cleaning device satisfies the extension-retraction action restriction condition.

In step 2021, a restricted area identification range is delineated according to an action position for triggering an extension-retraction action of the retractable mopping assembly, then whether the extension-retraction action is frequently triggered within the range is determined, and whether the extension-retraction action restriction condition is satisfied is determined according to a determination result.

Specifically, one acquired action position is taken as an identification start position, and an area with a preset shape and a preset size is constructed as a restricted area identification range by taking the identification start position as a center. The restricted area identification range may be in a shape such as a circle, a rectangle, a regular triangle, or a regular octagon. For example, taking the identification start position as a center of a triangle, an equilateral triangle area is constructed according to a preset side length as the restricted area identification range. After the restricted area identification range is determined, the number of action positions continuously acquired within the restricted area identification range is counted, that is, the number of times that the retractable mopping assembly triggers the extension-retraction action within the restricted area identification range is counted. If the counted number of times reaches the preset number of times, it is determined that the automatic cleaning device satisfies the extension-retraction action restriction condition, and then the extension-retraction action of the automatic cleaning device is restricted.

In step 2021, the determining the restricted area identification range of the preset size corresponding to the identification start position includes the following steps.

In step 20211, the restricted area identification range in a circular shape is constructed with the identification start position as a center of a circle and a preset length as a radius; or a rectangular area of a preset size is constructed as the restricted area identification range with the identification start position as a center.

In step 20211, the restricted area identification range may be in a circular or rectangular shape. Specifically, if the restricted area identification range is in a circular shape, a circular range is constructed by taking the identification start position as a center of a circle and the preset length as a radius. The preset length may be set according to a size of a self-cleaning robot, or may be set according to an extendable length of the retractable mopping assembly. For example, the preset length may be set to 2.5 times the radius of the body of the self-cleaning device. Similarly, if the restricted area identification range is in a rectangular shape, a rectangular area of a preset size is constructed by taking the identification start position as a center of a rectangle and a preset length as a side length. The preset side length and the preset size may be set according to a size of a self-cleaning robot or an extendable length of the retractable mopping assembly.

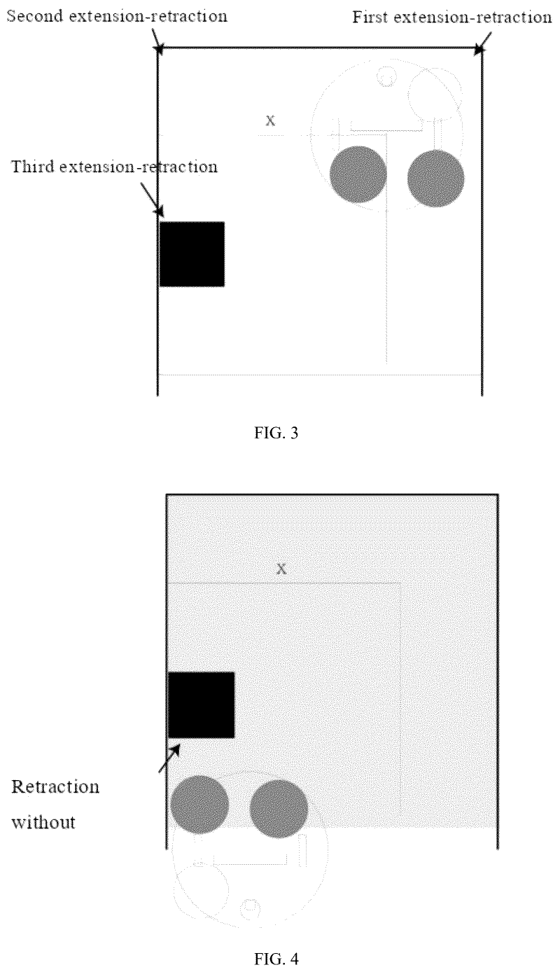

As shown in FIG. 3, a rectangular restricted area identification range is established with the automatic cleaning device as a center and x as a side length. Within the range, the retractable mopping assembly of the automatic cleaning device continuously triggers the extension-retraction action for three times, and it is determined that the automatic cleaning device satisfies the extension-retraction action restriction condition. Therefore, the capability of the automatic cleaning device to perform the extension-retraction action is restricted, and the retractable mopping assembly no longer performs the extension-retraction action within the range.

In step 203, when the automatic cleaning device satisfies the extension-retraction action restriction condition, an extension-retraction action restricted area corresponding to the automatic cleaning device is determined, the retractable mopping assembly is set to an extended state or a retracted state, and the usage restriction is imposed on the retractable mopping assembly within the extension-retraction action restricted area, so as to suspend a capability of the retractable mopping assembly to perform the extension-retraction action.

In step 203, if it is determined that the automatic cleaning device satisfies the extension-retraction action restriction condition, the extension-retraction action of the retractable mopping assembly is restricted. It can be understood that, since the automatic cleaning device is a movable device, during cleaning, the environment of the space where the automatic cleaning device is located changes accordingly as the automatic cleaning device moves. For example, when the automatic cleaning device moves to a new corner, if the extension-retraction action is restricted, the retractable mopping assembly cannot be extended, which may result in that the corner cannot be cleaned completely, thereby affecting the sweeping effect. Based on this, the extension-retraction action of the retractable mopping assembly may be restricted only in a certain area. If the automatic cleaning device moves out of the area, the restriction on the extension-retraction action is lifted. In an actual application process, the restricted area identification range may be directly determined as the extension-retraction action restricted area, and the state of the retractable mopping assembly is set to an extended state or a retracted state. The state of the retractable mopping assembly is kept unchanged within the extension-retraction action restricted area, so as to achieve the effect of suspending the retractable mopping assembly from performing the extension-retraction action.

As shown in FIG. 4, after constructing the restricted area identification range according to x, the range is determined as the extension-retraction action restricted area, and the state of the retractable mopping assembly is set to a retracted state. Thereafter, in the area, the retractable mopping assembly is always kept in the retracted state and no longer extends until the automatic cleaning device moves out of the extension-retraction action restricted area.

In step 203, the setting the retractable mopping assembly to the extended state or the retracted state includes the following steps.

In step 2031, the retractable mopping assembly is set to the extended state or the retracted state according to a preset usage restriction strategy corresponding to the retractable mopping assembly, where the preset usage restriction strategy includes one of a sweeping priority strategy, a safety priority strategy, and a working surface adaptation strategy, the sweeping priority strategy is configured to indicate that the retractable mopping assembly is set to the extended state under the usage restriction state of the retractable mopping assembly, the safety priority strategy is configured to indicate that the retractable mopping assembly is set to the retracted state under the usage restriction state of the retractable mopping assembly, and the working surface adaptation strategy is configured to indicate that the retractable mopping assembly is determined to be set to the extended state or the retracted state based on an area type of an area where the automatic cleaning device is located.

In step 2031, before the extension-retraction action of the retractable mopping assembly is restricted, the retractable mopping assembly is set to a certain extension-retraction state and kept unchanged. Specifically, the extension-retraction state may be determined according to the preset usage restriction strategy. The preset usage restriction strategy includes a sweeping priority strategy, a safety priority strategy, a working surface adaptation strategy, and the like. For example, if the preset usage restriction strategy is the sweeping priority strategy, it is considered that the current main goals are the sweeping effect and the sweeping efficiency, so that the retractable mopping assembly may be set to the extended state and kept unchanged in the extended state; if the preset usage strategy is the safety priority strategy, it is considered that the main goal is to ensure the sweeping safety and avoid collisions in the sweeping process, so that the retractable mopping assembly may be set to the retracted state and kept unchanged in the retracted state; and if the preset usage strategy is the working surface adaptation strategy, it is determined in a targeted manner whether to set the retractable mopping assembly to the extended state or the retracted state according to the working surface environment where the automatic cleaning device is currently located, so that the state of the retractable mopping assembly is more in line with the current operating environment, thereby ensuring both the cleaning effect and the safety in the sweeping process.

In step 2031, the setting, according to the preset usage restriction strategy corresponding to the retractable mopping assembly, the retractable mopping assembly to the extended state or the retracted state includes the following steps.

In step 20311, in a case that the preset usage restriction strategy corresponding to the retractable mopping assembly is the working surface adaptation strategy, an area type of an area where the automatic cleaning device is located is determined based on visual sensing data of the automatic cleaning device, and/or an area type of an area where the automatic cleaning device is located is determined based on historical map data of the automatic cleaning device.

In step 20312, the retractable mopping assembly is set to the extended state or the retracted state based on the area type.

In steps 20311-20312, if the preset usage strategy is the working surface adaptation strategy, the working surface environment where the automatic cleaning device is currently located is determined, and a state of the retractable mopping assembly is set in a targeted manner and locked. Specifically, the automatic cleaning device may be equipped with a visual sensing apparatus such as a camera and a radar. During operation of the automatic cleaning device, the visual sensing apparatus may capture environmental image information of an area where the automatic cleaning device is located in real time and transmit the environmental image information to the processor. The processor determines an area type of an area where the automatic cleaning device is located according to the environmental image information, and then sets a state of the retractable mopping assembly according to the area type. For example, a camera equipped on the automatic cleaning device captures an environmental image of a current position, and the processor determines that an area where the automatic cleaning device is located is a wall corner according to the environmental image. If the retractable mopping assembly is retracted, the wall corner cannot be effectively cleaned. Therefore, a state of the retractable mopping assembly may be set to an extended state. For another example, a camera equipped on the automatic cleaning device captures an environmental image of a current position, and the processor finds through analysis that a valuable object or a fragile object, such as a floor lamp or a vase, is placed around the automatic cleaning device. If the retractable mopping assembly is extended, there is a risk of colliding with the valuable object or the fragile object and causing damage to the valuable object or the fragile object. Therefore, a state of the retractable mopping assembly may be set to a retracted state.

In addition, the area type of the area where the automatic cleaning device is located may be determined according to historical map data of the automatic cleaning device. The automatic cleaning device may pre-store map data of an area to be cleaned, and correct the map data according to the acquired image information during operation, so as to ensure the validity of the historical map data. If the preset usage restriction strategy is the working surface adaptation strategy, the historical map data is read, the environment where the automatic cleaning device is currently located is determined in combination with the historical map data and the current positioning, and then the state of the retractable mopping assembly is set.

In step 204, the determination of whether the automatic cleaning device satisfies the extension-retraction action restriction condition is suspended.

In step 204, it can be understood that after imposing the usage restriction on the extension-retraction capability of the retractable mopping assembly, the retractable mopping assembly cannot perform the extension-retraction action any more. Therefore, it is not necessary to determine whether to restrict the extension-retraction capability of the retractable mopping assembly. Based on this, after imposing the usage restriction on the extension-retraction capability of the retractable mopping assembly, determination of the extension-retraction action restriction condition is suspended until the extension-retraction capability of the retractable mopping assembly is restored, and then the determination is continued. The automatic cleaning device shown in FIG. 3 performs extension-retraction for three consecutive times within the restricted area identification range, which satisfies the extension-retraction action restriction condition. After the capability of the retractable mopping assembly to perform the extension-retraction action is restricted, the determination of the extension-retraction action restriction condition is no longer performed within the range. The determination of the extension-retraction action restriction condition is resumed after the automatic cleaning device moves out of the restricted area identification range (as shown in FIG. 4) and the capability of the automatic cleaning device to perform the extension-retraction action is restored.

In step 205, the usage restriction on the retractable mopping assembly is maintained when the automatic cleaning device moves out of the extension-retraction action restricted area, and whether the automatic cleaning device satisfies an extension-retraction action restoration condition is determined based on operating data of the automatic cleaning device.

In step 206, the usage restriction on the retractable mopping assembly is lifted when the automatic cleaning device satisfies the extension-retraction action restoration condition, so as to restore the capability of the retractable mopping assembly to perform the extension-retraction action.

In steps 205-206, if the automatic cleaning device moves out of the extension-retraction action restricted area, it may be considered that the environment where the automatic cleaning device is currently located may change. For example, the automatic cleaning device always keeps the retractable mopping assembly in the retracted state within the extension-retraction action restricted area. If the automatic cleaning device moves to a new corner and still keeps the retractable mopping assembly in the retracted state, it will easily fail to clean the narrow corner, thereby leaving a sanitary blind spot and affecting the sweeping effect. Therefore, when the automatic cleaning device moves out of the extension-retraction action restricted area, whether to restore the capability of the retractable mopping assembly to perform the extension-retraction action may be re-evaluated. Specifically, an extension-retraction action restoration condition is preset, and whether the restoration condition is satisfied is determined based on the operating data of the automatic cleaning device. For example, whether the extension-retraction action restoration condition is satisfied may be determined according to surrounding environment information acquired by a camera or a radar, and whether the extension-retraction action restoration condition is satisfied may be determined according to a distance between the current position of the automatic cleaning device and the extension-retraction action restricted area. If the condition is satisfied, the usage restriction on the retractable mopping assembly for performing the extension-retraction action is lifted, and the capability of the retractable mopping assembly to perform the extension-retraction action is restored.

In step 205, the determining, based on the operating data of the automatic cleaning device, whether the automatic cleaning device satisfies the extension-retraction action restoration condition includes the following steps.

In step 2051, if the automatic cleaning device collides in a travelling direction or the automatic cleaning device continuously travels along an edge of an obstacle for a preset duration, it is determined that the automatic cleaning device satisfies the extension-retraction action restoration condition.

In step 2051, whether the extension-retraction action restoration condition is satisfied is determined according to collision data of the automatic cleaning device. Specifically, if the automatic cleaning device collides in the travelling direction, it is considered that the automatic cleaning device encounters a wall or other obstacles. Since the obstacle is likely to cause a sanitary blind spot, there is a difference between a sweeping manner near the obstacle and a sweeping manner on an open ground. Based on this, it may be determined that the automatic cleaning device satisfies the extension-retraction action restoration condition, and the restriction on the capability of the retractable mopping assembly to perform the extension-retraction action is lifted. In this case, the retractable mopping assembly may perform the extension-retraction action. Thereafter, the action position for triggering the retractable mopping assembly of the automatic cleaning device to perform the extension-retraction action continues to be acquired, so as to re-determine whether the extension-retraction action restriction condition is satisfied. If the extension-retraction action restriction condition is satisfied, the capability of the retractable mopping assembly to perform the extension-retraction action is re-restricted. In addition, if the automatic cleaning device continuously travels along the edge of the obstacle for a preset duration, for example, the automatic cleaning device in a narrow corner travels along the wall for a period of time, it may be considered that the automatic cleaning device leaves the narrow corner. Based on this, it may also be determined that the automatic cleaning device satisfies the extension-retraction action restoration condition.

In step 207, the determination of whether the automatic cleaning device satisfies the extension-retraction action restriction condition is resumed.

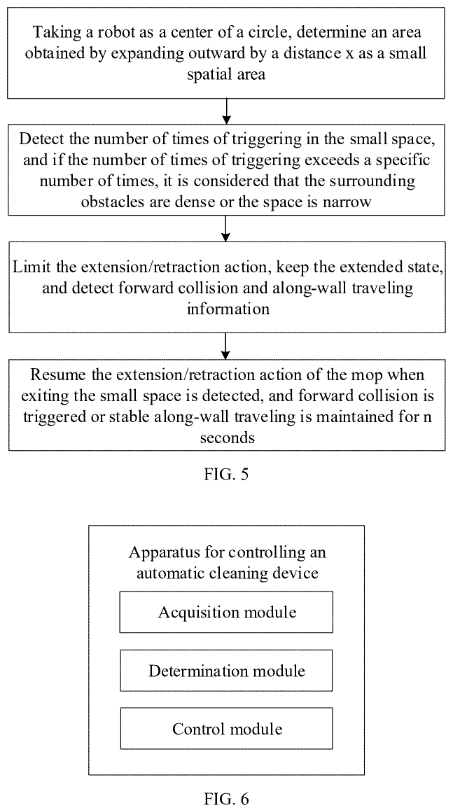

FIG. 5 shows a flowchart of another method for controlling the automatic cleaning device. As shown in the figure, a position where a robot, i.e., the automatic cleaning device, is located is comprehensively determined based on LDS point information or historical map information, and a small spatial area, i.e., a restricted area identification range, is obtained by extending outward by a distance x with the automatic cleaning device, i.e., the robot, as a center of a circle, where the small spatial area may be circular or rectangular. Then, the number of times that the retractable mopping assembly of the automatic cleaning device continuously triggers the extension-retraction action in the small spatial area is detected. If the number of times of triggering exceeds a preset threshold, it is considered that the extension-retraction action is frequent, and a cautious extension-retraction action needs to be performed. Therefore, the extension-retraction action is restricted. Since the extension-retraction action is triggered continuously for multiple times, it is considered that the obstacles around the robot are dense or the space is narrow. Based on this, the retractable mopping assembly may be set to the extended state and kept unchanged in the extended state, so as to more effectively clean the obstacle-dense area and the narrow space. After the robot leaves the area and collides with the wall or stably travels along the wall for n seconds, the restriction on the extension-retraction action is lifted, allowing the robot to resume the extension-retraction action.

In the embodiments of the present disclosure above, whether the retractable mopping assembly of the automatic cleaning device triggers the extension-retraction action is detected, and then the extension-retraction capability of the retractable mopping assembly is restricted when the extension-retraction action is frequent, so as to reduce the number of times of extension-retraction. By means of such a design, the wear of the retractable mechanism is reduced, the maintenance cost is lowered, and the service life of the automatic cleaning device is prolonged. In addition, since the extension-retraction action of the retractable mopping assembly needs to be driven by a motor, in the embodiments of the present disclosure above, by means of restricting the number of times of extension-retraction of the retractable mopping assembly in a specific area, additional power consumption due to frequent extension-retraction may be avoided, thereby reducing the energy consumption of the automatic cleaning device. When the automatic cleaning device leaves the extension-retraction action restricted area, whether to restore the capability of performing the extension-retraction action is determined according to the operating data of the automatic cleaning device, so as to prevent the automatic cleaning device from remaining restricted in the extension-retraction action when the automatic cleaning moves to other areas for sweeping, thereby reducing the sweeping efficiency and reducing the sweeping effect. Based on this, in the present disclosure, a plurality of different preset usage restriction strategies are set, and the state of the retractable mopping assembly is set in a targeted manner according to the strategies, thereby realizing the personalized restriction of the extension-retraction function.

It should be understood that sequence numbers of the steps in the above embodiments do not mean execution sequences. The execution sequences of the processes should be determined based on functions and internal logic of the processes, and should not be construed as any limitation on the implementation processes of the embodiments of the present disclosure above.

Further, as a specific implementation of the above method for controlling the automatic cleaning device, one embodiment of the present disclosure provides an apparatus for controlling an automatic cleaning device. As shown in FIG. 6, the apparatus includes an acquisition module, a determination module, and a control module.

The acquisition module is configured to continuously acquire, during operation of an automatic cleaning device, action positions where a retractable mopping assembly of the automatic cleaning device is triggered to perform an extension-retraction action;
the determination module is configured to determine, based on the plurality of action positions acquired, whether the automatic cleaning device satisfies an extension-retraction action restriction condition; and
the control module is configured to impose a usage restriction on the retractable mopping assembly when the automatic cleaning device satisfies the extension-retraction action restriction condition, so as to suspend a capability of the retractable mopping assembly to perform the extension-retraction action.

In one specific application scenario, optionally, the control module is configured to:
determine an extension-retraction action restricted area corresponding to the automatic cleaning device, and impose the usage restriction on the retractable mopping assembly within the extension-retraction action restricted area.

In one specific application scenario, optionally, the extension-retraction action restriction condition includes that the retractable mopping assembly continuously triggers the extension-retraction action for a preset number of times within a range of a preset size.

In one specific application scenario, optionally, the determination module is configured to:
taking any one of the action positions acquired as an identification start position, determine a restricted area identification range of the preset size corresponding to the identification start position;
count a number of times that the action positions continuously acquired from the identification start position fall within the restricted area identification range; and
if the number of times reaches a preset number of times, determine that the automatic cleaning device satisfies the extension-retraction action restriction condition.

In one specific application scenario, optionally, the determination module is configured to:
construct the restricted area identification range in a circular shape with the identification start position as a center of a circle and a preset length as a radius; or
construct a rectangular area with a preset size as the restricted area identification range with the identification start position as a center.

In one specific application scenario, optionally, the control module is configured to:
determine the restricted area identification range as the extension-retraction action restricted area.

In one specific application scenario, optionally, the determination module is configured to:
maintain the usage restriction on the retractable mopping assembly when the automatic cleaning device moves out of the extension-retraction action restricted area, and determine, based on operating data of the automatic cleaning device, whether the automatic cleaning device satisfies an extension-retraction action restoration condition; and
correspondingly, the control module is configured to:
lift the usage restriction on the retractable mopping assembly when the automatic cleaning device satisfies the extension-retraction action restoration condition, so as to restore the capability of the retractable mopping assembly to perform the extension-retraction action.

In one specific application scenario, optionally, the determination module is configured to:
if the automatic cleaning device collides in a travelling direction or the automatic cleaning device continuously travels along an edge of an obstacle for a preset duration, determine that the automatic cleaning device satisfies the extension-retraction action restoration condition.

In one specific application scenario, optionally, the determination module is configured to:
suspend the determination of whether the automatic cleaning device satisfies the extension-retraction action restriction condition; and
resume the determination of whether the automatic cleaning device satisfies the extension-retraction action restriction condition.

In one specific application scenario, optionally, the control module is also configured to:
set the retractable mopping assembly to an extended state or a retracted state.

In one specific application scenario, optionally, the control module is configured to:
set, according to a preset usage restriction strategy corresponding to the retractable mopping assembly, the retractable mopping assembly to the extended state or the retracted state,
where the preset usage restriction strategy includes one of a sweeping priority strategy, a safety priority strategy, and a working surface adaptation strategy, the sweeping priority strategy is configured to indicate that the retractable mopping assembly is set to the extended state under the usage restriction state of the retractable mopping assembly, the safety priority strategy is configured to indicate that the retractable mopping assembly is set to the retracted state under the usage restriction state of the retractable mopping assembly, and the working surface adaptation strategy is configured to indicate that the retractable mopping assembly is determined to be set to the extended state or the retracted state based on an area type of an area where the automatic cleaning device is located.

In one specific application scenario, optionally, the control module is configured to:
in a case that the preset usage restriction strategy corresponding to the retractable mopping assembly is the working surface adaptation strategy, determine, based on visual sensing data of the automatic cleaning device, an area type of an area where the automatic cleaning device is located, and/or determine, based on historical map data of the automatic cleaning device, an area type of an area where the automatic cleaning device is located; and
set, based on the area type, the retractable mopping assembly to the extended state or the retracted state.

It should be noted that, for other corresponding descriptions of the functional modules involved in the apparatus for controlling the automatic cleaning device according to the embodiments of the present disclosure above, reference may be made to the corresponding descriptions in the above method, and details are not described herein again.

Based on the above method, correspondingly, one embodiment of the present disclosure also provides a storage medium storing a computer program. The program, when run by a processor, causes the processor to perform the above method for controlling the automatic cleaning device.

Based on such an understanding, the technical solutions according to the present disclosure may be implemented in the form of a software product. The software product may be stored in a non-volatile storage medium (which may be a CD-ROM, a USB flash drive, a mobile hard disk, or the like), and includes several instructions for instructing an automatic cleaning device (which may be a personal computer, a server, a network device, or the like) to perform the method according to the implementation scenarios of the present disclosure.

The storage medium may also include an operating system and a network communication module. The operating system is the program that manages and maintains the hardware and software resources of the automatic cleaning device, and supports the operation of an information processing program and other software and/or programs. The network communication module is configured to implement the communication between the components inside the storage medium, and the communication with other hardware and software in the physical device.

Based on the method shown in FIGS. 1 to 5 and the virtual apparatus embodiment shown in FIG. 6, in order to achieve the above objectives, one embodiment of the present disclosure also provides an automatic cleaning device, which may be specifically a sweeping robot or the like. The automatic cleaning device includes a storage medium and a processor. The storage medium is configured to store a computer program. The processor is configured to execute the computer program to perform the method for controlling the automatic cleaning device shown in FIGS. 1 to 5.

Optionally, the automatic cleaning device may also include a user interface, a network interface, a camera, a radio frequency (RF) circuit, a sensor, an audio circuit, a WI-FI module, and the like. The user interface may include a display, an input unit, and the like. An optional user interface may also include a USB interface, a card reader interface, and the like. The network interface may optionally include a standard wired interface, a standard wireless interface (such as a Bluetooth interface and a WI-FI interface), and the like.

Those skilled in the art can understand that the structure of an automatic cleaning device provided in the embodiment above does not constitute a limitation on the automatic cleaning device, and may include more or fewer components, or combine some components, or have different component arrangements.

Based on the descriptions of the above embodiments, those skilled in the art can clearly understand that the present disclosure may be implemented by the mode of software in combination with a necessary general hardware platform, or may be implemented by hardware.

Those skilled in the art can understand that the drawings are merely schematic diagrams of a preferred implementation scenario, and the units or processes shown in the drawings are not necessarily required for implementing the present disclosure. Those skilled in the art can understand that units of the apparatus in the implementation scenario may be distributed in the apparatus in the implementation scenario based on the description of the implementation scenario, or may be correspondingly modified to be located in one or more apparatuses different from that in the present implementation scenario. The units in the above implementation scenario may be combined into one unit, or may be further divided into a plurality of subunits.

The serial numbers of the present disclosure are merely for description, and do not represent the advantages and disadvantages of the implementation scenarios. The content disclosed above is merely several specific implementation scenarios according to the present disclosure, but the present disclosure is not limited thereto. Any variation that can be conceived by those skilled in the art shall fall within the protection scope of the present disclosure.

1. A method for controlling an automatic cleaning device, comprising:
continuously acquiring, during operation of an automatic cleaning device, a plurality of action positions where a retractable mopping assembly of the automatic cleaning device is triggered to perform an extension-retraction action;
determining, based on the plurality of action positions acquired, whether the automatic cleaning device satisfies an extension-retraction action restriction condition; and
imposing a usage restriction on the retractable mopping assembly in response to determining that the automatic cleaning device satisfies the extension-retraction action restriction condition, to suspend a capability of the retractable mopping assembly to perform the extension-retraction action.

2. The method according to claim 1, wherein the imposing the usage restriction on the retractable mopping assembly comprises:
determining an extension-retraction action restricted area corresponding to the automatic cleaning device, and imposing the usage restriction on the retractable mopping assembly within the extension-retraction action restricted area.

3. The method according to claim 2, wherein the extension-retraction action restriction condition comprises that the retractable mopping assembly continuously triggers the extension-retraction action for a preset number of times within a range of a preset size, wherein the determining, based on the plurality of action positions acquired, whether the automatic cleaning device satisfies the extension-retraction action restriction condition comprises:
taking any one of the action positions acquired as an identification start position, determining a restricted area identification range of the preset size corresponding to the identification start position;
counting a number of times that the action positions continuously acquired from the identification start position fall within the restricted area identification range; and
in response to determining that the number of times reaches a preset number of times, determining that the automatic cleaning device satisfies the extension-retraction action restriction condition.

4. The method according to claim 3, wherein the determining the restricted area identification range of the preset size corresponding to the identification start position comprises:
constructing the restricted area identification range in a circular shape with the identification start position as a center of a circle and a preset length as a radius; or
constructing a rectangular area with a preset size as the restricted area identification range with the identification start position as a center, or
wherein the determining the extension-retraction action restricted area corresponding to the automatic cleaning device comprises:
determining the restricted area identification range as the extension-retraction action restricted area.

5. The method according to claim 2, wherein after the imposing the usage restriction on the retractable mopping assembly, the method further comprises:
maintaining the usage restriction on the retractable mopping assembly in response to determining that the automatic cleaning device moves out of the extension-retraction action restricted area, and determining, based on operating data of the automatic cleaning device, whether the automatic cleaning device satisfies an extension-retraction action restoration condition; and
lifting the usage restriction on the retractable mopping assembly in response to determining that the automatic cleaning device satisfies the extension-retraction action restoration condition, to restore the capability of the retractable mopping assembly to perform the extension-retraction action.

6. The method according to claim 5, wherein the determining, based on the operating data of the automatic cleaning device, whether the automatic cleaning device satisfies the extension-retraction action restoration condition comprises:
in response to determining that the automatic cleaning device collides in a travelling direction or the automatic cleaning device continuously travels along an edge of an obstacle for a preset duration, determining that the automatic cleaning device satisfies the extension-retraction action restoration condition, or
wherein after the imposing the usage restriction on the retractable mopping assembly, the method further comprises:
suspending the determination of whether the automatic cleaning device satisfies the extension-retraction action restriction condition; and
correspondingly, after the lifting the usage restriction on the retractable mopping assembly, the method further comprises:
resuming the determination of whether the automatic cleaning device satisfies the extension-retraction action restriction condition.

7. The method according to claim 1, wherein before the imposing the usage restriction on the retractable mopping assembly, the method further comprises:
setting the retractable mopping assembly to an extended state or a retracted state.

8. The method according to claim 7, wherein the setting the retractable mopping assembly to the extended state or the retracted state comprises:
setting, according to a preset usage restriction strategy corresponding to the retractable mopping assembly, the retractable mopping assembly to the extended state or the retracted state,
wherein the preset usage restriction strategy includes one of a sweeping priority strategy, a safety priority strategy, and a working surface adaptation strategy, the sweeping priority strategy is configured to indicate that the retractable mopping assembly is set to the extended state under the usage restriction state of the retractable mopping assembly, the safety priority strategy is configured to indicate that the retractable mopping assembly is set to the retracted state under the usage restriction state of the retractable mopping assembly, and the working surface adaptation strategy is configured to indicate that the retractable mopping assembly is determined to be set to the extended state or the retracted state based on an area type of an area where the automatic cleaning device is located.

9. The method according to claim 8, wherein the setting, according to the preset usage restriction strategy corresponding to the retractable mopping assembly, the retractable mopping assembly to the extended state or the retracted state comprises:
in a case that the preset usage restriction strategy corresponding to the retractable mopping assembly is the working surface adaptation strategy, determining, based on visual sensing data of the automatic cleaning device, an area type of an area where the automatic cleaning device is located, and/or determining, based on historical map data of the automatic cleaning device, an area type of an area where the automatic cleaning device is located; and
setting, based on the area type, the retractable mopping assembly to the extended state or the retracted state.

10. An automatic cleaning device, comprising: a non-transitory storage medium, a processor, and a computer program stored in the non-transitory storage medium and executable by the processor, wherein the processor, when running the computer program, is configured to:
continuously acquire, during operation of the automatic cleaning device, a plurality of action positions where the retractable mopping assembly of the automatic cleaning device is triggered to perform an extension-retraction action;
determine, based on the plurality of action positions acquired, whether the automatic cleaning device satisfies an extension-retraction action restriction condition; and
impose a usage restriction on the retractable mopping assembly in response to determining that the automatic cleaning device satisfies the extension-retraction action restriction condition, to suspend a capability of the retractable mopping assembly to perform the extension-retraction action.

11. The device according to claim 10, wherein the processor is further configured to:
determine an extension-retraction action restricted area corresponding to the automatic cleaning device, and impose the usage restriction on the retractable mopping assembly within the extension-retraction action restricted area.

12. The device according to claim 11, wherein the extension-retraction action restriction condition comprises that the retractable mopping assembly continuously triggers the extension-retraction action for a preset number of times within a range of a preset size.

13. The device according to claim 12, wherein the processor is further configured to:
take any one of the action positions acquired as an identification start position, determine a restricted area identification range of the preset size corresponding to the identification start position;
count a number of times that the action positions continuously acquired from the identification start position fall within the restricted area identification range; and
in response to determining that the number of times reaches a preset number of times, determine that the automatic cleaning device satisfies the extension-retraction action restriction condition.

14. The device according to claim 13, wherein the processor is further configured to:
construct the restricted area identification range in a circular shape with the identification start position as a center of a circle and a preset length as a radius; or
construct a rectangular area with a preset size as the restricted area identification range with the identification start position as a center, or
wherein the processor is further configured to:
determine the restricted area identification range as the extension-retraction action restricted area.

15. The device according to claim 11, wherein the processor is further configured to:
maintain the usage restriction on the retractable mopping assembly in response to determining that the automatic cleaning device moves out of the extension-retraction action restricted area, and determine, based on operating data of the automatic cleaning device, whether the automatic cleaning device satisfies an extension-retraction action restoration condition; and
wherein the processor is further configured to:
lift the usage restriction on the retractable mopping assembly in response to determining that the automatic cleaning device satisfies the extension-retraction action restoration condition, to restore the capability of the retractable mopping assembly to perform the extension-retraction action.

16. The device according to claim 15, wherein the processor is further configured to:
in response to determining that the automatic cleaning device collides in a travelling direction or the automatic cleaning device continuously travels along an edge of an obstacle for a preset duration, determine that the automatic cleaning device satisfies the extension-retraction action restoration condition, or
wherein the processor is further configured to:
suspend the determination of whether the automatic cleaning device satisfies the extension-retraction action restriction condition; and
resume the determination of whether the automatic cleaning device satisfies the extension-retraction action restriction condition.

17. The device according to claim 10, wherein the processor is further configured to:
set the retractable mopping assembly to an extended state or a retracted state.

18. The device according to claim 17, wherein the processor is further configured to:
set, according to a preset usage restriction strategy corresponding to the retractable mopping assembly, the retractable mopping assembly to the extended state or the retracted state,
wherein the preset usage restriction strategy includes one of a sweeping priority strategy, a safety priority strategy, and a working surface adaptation strategy, the sweeping priority strategy is configured to indicate that the retractable mopping assembly is set to the extended state under the usage restriction state of the retractable mopping assembly, the safety priority strategy is configured to indicate that the retractable mopping assembly is set to the retracted state under the usage restriction state of the retractable mopping assembly, and the working surface adaptation strategy is configured to indicate that the retractable mopping assembly is determined to be set to the extended state or the retracted state based on an area type of an area where the automatic cleaning device is located.

19. The device according to claim 18, wherein the processor is further configured to:
in a case that the preset usage restriction strategy corresponding to the retractable mopping assembly is the working surface adaptation strategy, determine, based on visual sensing data of the automatic cleaning device, an area type of an area where the automatic cleaning device is located, and/or determine, based on historical map data of the automatic cleaning device, an area type of an area where the automatic cleaning device is located; and
set, based on the area type, the retractable mopping assembly to the extended state or the retracted state.

20. A non-transitory storage medium storing a computer program, wherein the computer program, when run by a processor, causes the processor to:
continuously acquire, during operation of the automatic cleaning device, a plurality of action positions where the retractable mopping assembly of the automatic cleaning device is triggered to perform an extension-retraction action;
determine, based on the plurality of action positions acquired, whether the automatic cleaning device satisfies an extension-retraction action restriction condition; and
impose a usage restriction on the retractable mopping assembly in response to determining that the automatic cleaning device satisfies the extension-retraction action restriction condition, to suspend a capability of the retractable mopping assembly to perform the extension-retraction action.
